(19) United States
(12) Patent Application Publication
(10) Pub. No.: US 2014/0213664 A1
(43) Pub. Date: Jul. 31, 2014

(54) PROCESSES, PRODUCTS AND METHODOLOGIES FOR MAKING AND USING NOVEL BIOADVANTAGED SWEETENERS

(71) Applicant: Alexandra Damsker, Playa Vista, CA (US)

(72) Inventor: Alexandra Damsker, Playa Vista, CA (US)

(21) Appl. No.: 14/167,660

(22) Filed: Jan. 29, 2014

Related U.S. Application Data
(60) Provisional application No. 61/757,880, filed on Jan. 29, 2013.

(51) Int. Cl. A23L 1/236

(52) U.S. Cl. CPC A23L 1/2363
USPC 514/777; 426/658; 426/660; 426/549; 426/618; 426/573; 426/589; 426/590

(57) ABSTRACT

Bioadvantaged Sweeteners leverage chemical synergies of combining select ratios of certain formulations of lactose and glucose with, for example, purified phlorizin for unexpectedly better results than predicted by prior art as a whole. Glucometer data confirms employing such Bioadvantaged Sweetener with conventional and enhanced delivery systems facilitates stasis at points of peak blood sugar saturation for users.

### CROSS-REFERENCE TO RELATED APPLICATIONS

This application claims priority to, and full Paris Convention benefit of, U.S. Provisional Application Ser. No. 61/757,880 and expressly incorporates the same and all United States Letters Patents referenced therein, as if expressly set forth herein, in addition to those disclosed herein, with equal dignity.

### BACKGROUND OF THE INVENTIONS

The present inventions relate to processes for making novel sweetening agents, foodstuffs, baked products and other consumable items using combinations of these desiderata. In particular, the present inventions contemplate novel sweetener processes, products, methodologies and approaches which allow resultory products which have, among other things lower glucometer readings upon ingestion by humans than expected to be generated based upon known and established science and technology.

Owing to the overwhelming needs of consumers to procure low glycemic index finished products, ingredients and sustenance properly reflecting sugar-types with labeling proffered—a longstanding need exists to provide visible and transparent, healthful alternatives to those items with higher glycemic indices and ambiguous labels. These sets of desiderata span a large continuum of needs both from those with ostensively normal metabolisms to those who are physiologically challenged.

### OBJECTS AND SUMMARY OF THE DISCLOSURE

Briefly stated, Bioadvantaged Sweeteners leverage phytochemicals and can be generated with unexpectedly better results than existing sugar complexes for animals ingesting them, including enhanced approaches to generate baked goods. The disclosure provides the advantage of lower glycemic index products along with the novel Bioadvantaged Sweetners.

According to embodiments, there is disclosed an improved set of processes for generating and using enhanced sweeteners by determining desired sugar-related chemical properties, selecting sweetness levels, formulating a ratio of lactose (amorphous granulated) to glucose (granulated) formulating by combination with purified phlorizin, and using for baked products under 420 degrees Fahrenheit, for example.

According to embodiments, there is likewise disclosed an invert sugar version which is shelf stable and free of fructose, with concomitant glycemic index advantages.

According to embodiments, an invert sugar is offered for consideration whereby, according to an exemplary embodiments, approximately 225 g is generated from a combination of approximately 100 g each of lactose, 100 g of glucose, 20 g of phlorizin, along with ⅓ cup water, ⅛ tsp salt, and ¼ tsp cream of tartar; which ingredients are combined, stirred, boiled and simmered (without stirring), covered and cooked to a soft ball stage prior to storage.

### BRIEF DESCRIPTION OF THE DRAWINGS

FIG. 1 shows a granulated sweetener process for baked goods/non-baked goods according to the present inventions;

FIG. 2 shows a process of generating purified phlorizin according to teachings of the present invention;

FIG. 3 shows an exemplary baked goods recipe according to the present invention;

FIG. 4 shows an exemplary recipe for a frozen liqueur drink according to the present invention;

FIG. 5 shows comparative glucometer readings according to the present invention;

FIG. 6 shows comparative glucometer readings using lactose and glucose according to the present invention;

FIG. 7 shows glucometer readings using lactose, glucose and phlorizin according to embodiments of the present invention.

### DETAILED DESCRIPTION OF THE DISCLOSURE

The present inventor has discovered operative combinations of lactose, glucose, and phlorizin (optionally) which define novel sweeteners and products. The present inventor has discovered that combinations of conventional baking theory and novel phytochemical approaches to the isolation of actives yields novel Bioadvantaged Sweeteners.

For the purpose of this application, Bioadvantaged Sweeteners are defined as those developed by the present inventor combining at least a preferred ratio of lactose (amorphous granulated) with glucose (granulated) and phlorizin (or any appropriate alternative) in an amount equal to at least about 10 percent of the prior mixture. It is respectfully proposed that such Bioadvantaged Sweeteners have not been made previously discovered, classified, tested empirically nor been available commercially—prior to the advent of the instant teachings. It is further respectfully submitted that this constitutes progress in science and the useful arts worthy of Letters Patent protection, which is hereby earnestly solicited.

Medicinal plants have been a driving force behind herbal medicine worldwide since antiquity. The therapeutic use of plants goes back to the Sumerian and the Akkadian civilizations in about the third millenium BC. Hippocrates (ca. 460-377 BC), listed approximately 400 different plant species for medicinal purposes. Natural products have been an integral part of the three dominant ancient traditional medicine systems, e.g. Chinese, Ayurvedic and Egyptian (Sacker & Nahar, 2007), according both to pundits and those who have attempted to leverage anthropological and culture treasures for profit.

About 3.4 billion people in the developing world depend on plant-based traditional medicines. According to the World Health Organization, a medicinal plant is any plant which, in one or more of its organs, contains substances that can be used for therapeutic purposes, or which are precursors for chemo-pharmaceutical semi synthesis. Such a plant will have its parts including leaves, roots, rhizomes, stems, barks, flowers, fruits, grains or seeds, employed in the control or treatment of a disease condition and therefore contains chemical components that are medically active, albeit not always described in conventional Western terms, or characterized by mechanisms of action in accepted chemical parlance. This provides challenges and opportunities.

The science of application of these indigenous or local medicinal remedies including plants for treatment of diseases is currently called ethno-pharmacology but the practice dates back past the dawn of written history. Ethno-pharmacology has been the mainstay of traditional medicines of the entire world and currently is being integrated into mainstream and Western Medicine. However, that being said, baking and the confectionary arts have evolved along different pathways, with some overlap and according to available data and historical reviews and treatments have vastly different operational constraints. Exploring salient aspects of these disparate technical spaces yields a better understanding of how innovations can bridge ostensive gaps between them.

Glycosides are defined as the condensation products of sugars. Glycosides are colorless, crystalline carbon, hydrogen and oxygen-containing water-soluble phytoconstituents, found in the cell sap. Chemically, glycosides contain a carbohydrate (glucose) and a non-carbohydrate part (aglycone or benin) (Kar, 2007; Firn, 2010). Alcohol, glycerol or phenol represents aglycones. Glycosides are neutral in reaction and can be readily hydrolyzed into its components with ferments or mineral acids. Glycosides are classified on the basis of type of sugar component, chemical nature of aglycone or pharmacological action. However, the systematic names are invariably coined by replacing the “ose” suffix of the parent sugar with “aside”. This group of drugs is usually administered in order to promote appetite and aid digestion. Glycosides are purely bitter principles that are commonly found in plants of the Genitiaceae family and though they are chemically unrelated but possess the common property of an intensely bitter taste.

Flavonoids are an important group of polyphenols widely distributed among the plant flora. The compounds are derived from parent compounds known as flavans. Over four thousand flavonoids are known to exist and some of them are pigments in higher plants. Other group of flavonoids include flavones, flavonols, anthocyanidins, proanthocyanidins, calchones and catechin and leucoanthocyanidins.

Tannins, likewise are widely distributed in plant flora. They are phenolic compounds of high molecular weight. Tannins are soluble in water and alcohol and are found in the root, bark, stem and outer layers of plant tissue. Tannins have a characteristic feature to tan, i.e. to convert things into leather. They are acidic in reaction.

Antioxidants are often added to foods to prevent the radical chain reactions of oxidation, and they act by inhibiting the initiation and propagation step leading to the termination of the reaction and delay the oxidation process. Due to safety concerns of synthetic compounds, food industries have focused on finding natural antioxidants to replace synthetic compounds. In addition, there is growing trend in consumer preferences for natural antioxidants, all of which has given more impetus to explore natural sources of antioxidants. No general agreement has been achieved to date with respect to many of the involved technical issues.

Cinnamaldehyde, a phytoconstituent extracts have been reported to exhibit significant antihyperglycemic effect resulting in the lowering of both total cholesterol and triglyceride levels and, at the same time, increasing HDL-cholesterol in STZ-induced diabetic rats. This potential of cinnamaldehyde for use as a natural oral agent, both hypoglycaemic and hypolipidemic effects.

Multiple molecular targets of dietary phytochemicals have been identified, and these tend to aim at a multitude of molecular targets. It is because of these characteristics that definitive mechanisms of action are not available despite decades of research, in many instances, although efficacy and feasibility have been established.

No single method is sufficient to study the bioactivity of phytochemicals from a given plant. In sum, plants are natural reservoir of medicinal agents almost free from the side effects normally caused by synthetic chemicals (Fennel et al., 2004). The World Health Organization estimates that herbal medicine is still the main stay of about 75-80% of the world population, mainly in the developing countries for primary health care because of better cultural acceptability, better compatibility with the human body, and lesser side-effects. The over use of synthetic drugs with impurities resulting in higher incidence of adverse drug reactions has motivated mankind to go back to nature for safer remedies.

This is in contradistinction to pharmacology, as there are few disadvantages associated with natural products research. These include difficulties in access and supply, complexities of natural product chemistry and inherent slowness of working with natural products. In addition, there are concerns about intellectual property rights, and the inherent risks associated with the use of collections of compounds prepared by combinatorial chemistry methods. However, on balance given the paucity of available choices, bakers have now embraced and re-aligned chemical moieties rejected by, or overlooked by traditional drug discovery.

Most of the leads from natural products that are currently in development have come from either plant or microbial sources. Earlier publications have pointed out that relatively little of the world's plant biodiversity has been extensively screened for bioactivity. With the growing realization that the chemical diversity of natural products is a better match to that of successful drugs than the diversity of collections of synthetic compounds and with the global emergence of multidrug resistant pathogens the interest in applying natural chemical diversity to drug discovery appears to be increasing once again. Meanwhile, food ingestion and preparation continues to evolve along parallel paths, by necessity for those who daily extract, combine and formulate healthful products to eat and palliatively use. This tension has produced many needs and addressed others with results that are not linearly intuitive to those skilled in the chemical arts.

Despite all of the advances made by the pharmaceutical industry in the development of novel and highly effective medicines for the treatment of a wide range of diseases, there has been a marked increase in the use of herbal medicines even including the more affluent countries of the world. Germany has the largest share of the market in Europe.

Scientific and Research communities are currently engaged in phytochemical research, and pharmacognosy, phytomedicine or traditional medicine are various disciplines in higher institutions of learning that deal specifically with research in herbal medicines.

With the increasing interest and so many promising drug candidates that are of natural origin, and with the lessening of technical drawbacks associated with natural product research, there are better opportunities to explore the biological activity of previously inaccessible sources of natural products. In addition, the increasing acceptance that the chemical diversity of natural products is well suited to provide the core scaffolds for future drugs, there will be further developments in the use of novel natural products. However, as animals and humans continue to need to eat, solutions from other avenues often occur and complement more focused science.

Expressly incorporated by reference as if fully set forth herein are the following Patents and Publications: U.S. Pat. No. 6,638,544; U.S. Pat. No. 6,777,397; U.S. Pat. No. 7,650,443; U.S. Pat. No. 2,629,662; and Chinese Patent Publication Numbered CN 102643315A (CN App. 20121012671).

As used herein, the definition of Phlorizin (also phloridzin, phlorihzin, phlorhizin, and a few other spellings) is as follows: a bitter crystalline glucoside C₂₁H₂₄O₁₀ that is extracted from root bark or bark (as of the apple, pear, or cherry), produces glycosuria if injected hypodermically, and is used chiefly in producing experimental diabetes in animals. The present inventor has synthesized various technical sources to create information accessible to those who need to use it.

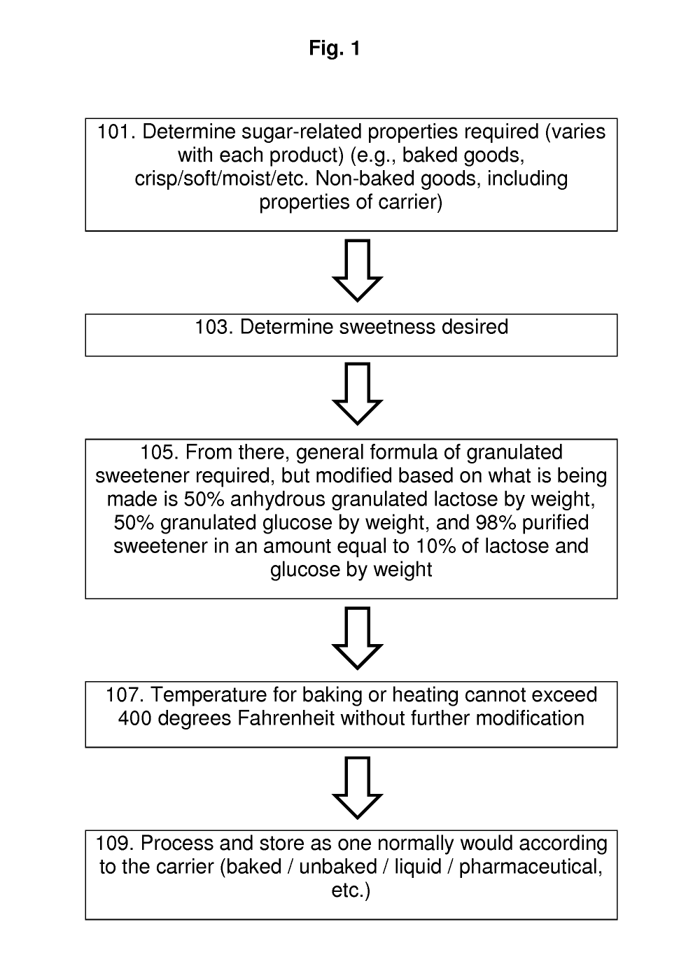

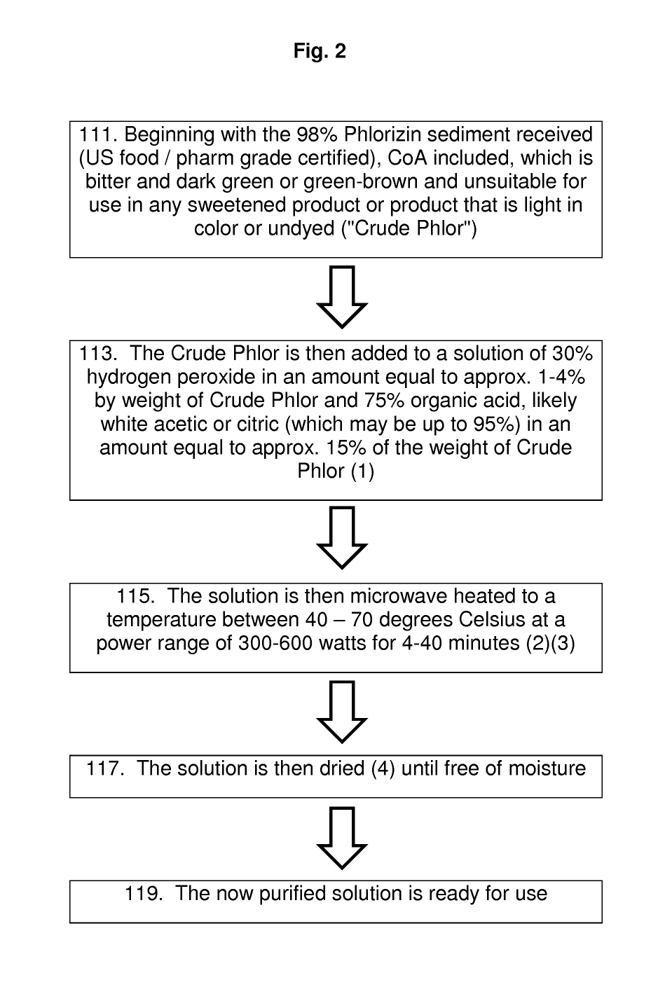

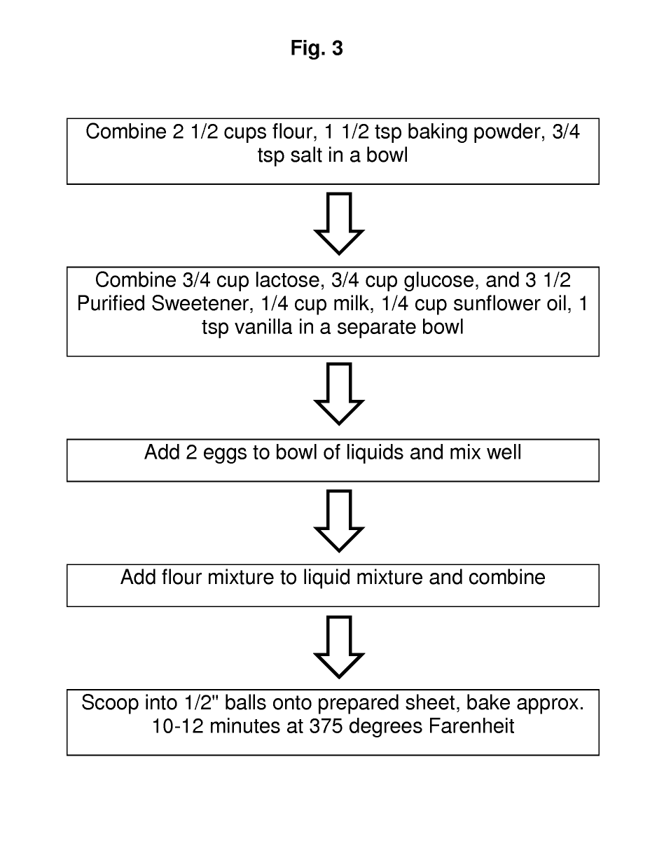

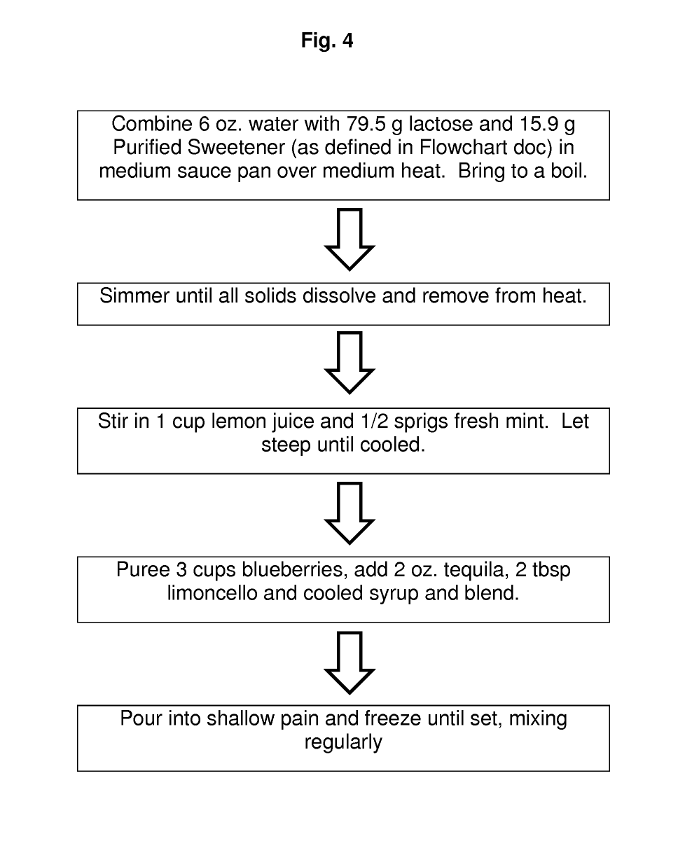

Referring now to FIG. 1, a granulated sweetener process is shown, according to the present inventions, for baked and non-baked goods. A first step 101, involves selection of those properties for the particular good to be produced as would be known to those skilled in the art (see also FIG. 3 and FIG. 4 for two different examples). The next step 103 includes a sweetness determination. Following these determinations, a ratio-based general formulation is developed at step 105, with phlorizin an example of a purified sweetener (see also FIG. 2). Steps 107 and 109 are for baking, at less than 400 degrees Fahrenheit and processing and storage. Those skilled in the baking and/or confectionary arts readily understand that recipes are, like chemical formulations, tested by trial and error. The present inventor has optimized Bioadvantaged Sweeteners, and further details of products embodying the same follow. FIG. 2 has resulted from a year long process of experimentation and trial and error baking and formulated research. Despite the fact that many prior art references and documents essentially teach away from what has been discovered, namely that forms of lactose and glucose, when combined with phlorizin do not cause predicted blood-sugar spikes, the present inventor (without limiting herself to one particular mechanism) has leveraged this learning into baked goods and Bioadvantaged Sweeteners.

Turning now also to FIGS. 2, 3, and 4, a phlorizin purification process beings with “Crude Phlor” at step 111. Step 113 adds the stacking product to 30% hydrogen peroxide, as described. Step 115 heats the solution in a microwave oven between at least about 40-70 degrees. Step 117 is drying and Step 119 finishing, as needed.

FIG. 3 and FIG. 4 each embody palatable and potable examples created according to the instant teachings. (Kira's Kiss Desserts, Playa Vista, Calif., 90094-4020.)

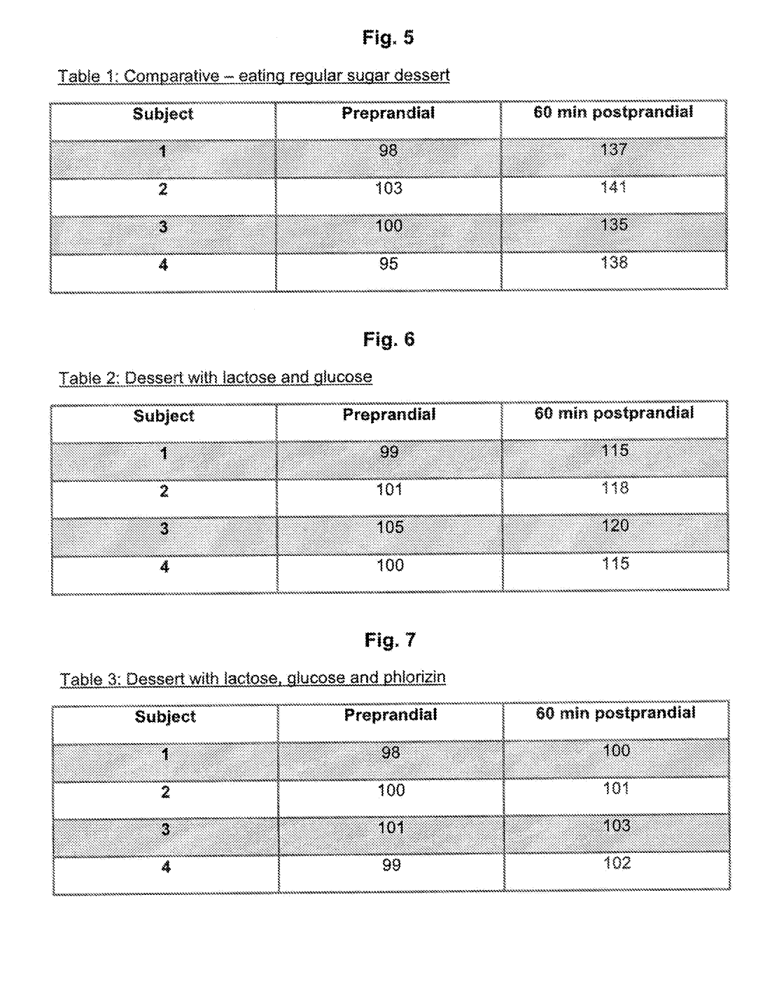

Likewise, FIGS. 5, 6, and 7 show tables of comparative results in terms of standard glucometer readings (One-Touch Ultra 2® brand of glucometer, Lifescan, Inc., Milpitas, Calif., 95035.)

The present inventor has created novel enhanced Bioadvantaged Sweeteners based upon both needs to manage baking issues (needed calibrations of sweetness, texture, scalability) and to offer for consideration foodstuffs and sweetening agents which users/consumers need to manage their blood-sugar which is both palliative and nutritionally driven.

FIG. 3 shows an example of sugar cookies prepared according to embodiments of the present inventions. Those of skill in the arts of baking readily understand all details which have not been added, for clarity. The (amorphous granulated) lactose (NOW® Real Food Brands, Los Angeles, Calif., 90049) and (granulated) glucose (NOW® Real Food Brands Sports Dextrose Powder Quick Energy Fuel, Los Angeles, Calif., 90049) are available commercially, and support the teachings of the present inventions.

Likewise, referring to FIG. 4, the Bioadvantaged Sweeteners work conveniently well for numerous potables. A simple example is the LEMON BLUBERRY MINT GRANITA, which is like a daiquiri, but served chipped and not blended.

Once again the (amorphous granulated) lactose and (granulated) glucose are sourced from NOW® Real Food Brands (Los Angeles, Calif., 90049) and the 98% pure phlorizin from Xi'an Aladdin Biological Technology Co., Ltd. (No. 56 Xiaozhai Road, Ya to district, Xi'an, China).

FIG. 5 shows glucometer readings taken from five subjects before eating and sixty-minutes after eating conventional, sugar-based dessert products. The preprandial figure is taken using a lancet, procuring a blood sample and then testing the same on a One-Touch Ultra 2® brand of glucometer (Lifescan, Inc., Milipitas, Calif., 95035) before eating, and 60 minutes after eating. Referring now to FIG. 5—typical humans without negative physiological conditions of their metabolism demonstrate spikes or increases of approximately 30-50 points in mg/dL one hour after ingesting. This is standard in-field glucose monitoring.

Referring now to FIG. 6, the present inventor has spent inordinate amounts of time debunking the purported glycemic index impacts of other products (including those alleged to have different results than disclosed, for example, in U.S. Pat. No. 7,560,443 and numerous food labels). Table 2 presents typical blood-sugar ranges in mg/dL for healthy individuals ingesting desserts with lactose and glucose. A typical delta of at least about 15 mg/dL difference is noted, using such standard testing.

Referring now to FIG. 7, a dessert product (such as the examples of FIG. 3 a baked product, and FIG. 4 a potable liquor-based product) prepared using the aforementioned Bioadvantaged Sweeteners registers between 1 and 3 points higher in terms of mg/dL, which is unexpectedly better than any chemical process reviewed, surveyed and researched would suggest. In short, the present inventor has been able to make gustatorily pleasing (good/sweet tasting) products that do not impact blood sugar—which is not predictable based on chemistry alone, because others have tried for years unsuccessfully.

As disclosed herein, Phlorizin likewise apparently has recently been successfully extracted from a particular type of sweet tea leaves, Lithocarpus polystachyus Rehd, “Preparative Separation and Identification of the Flavonoid Phlorhizin from the Crude Extract of Lithocarpus Polystachyus Rehd” (2007). This is important because the initial separation is much cleaner and allows for more frequent reaping, as apple bark can typically only be harvested once (possibly twice) per year (the winter harvest has different properties and can be far more expensive). The present inventor uses the products entirely extracted and in powder form, which is bitter and darkly colored, but at least 98% pure. Contemplated by the instant teachings is phlorizin cleanly from a live, healthy, environmentally grown stock to provide pure supply in the United States.

Referring once again to FIG. 2, from 98% minimum pure powder received (with certifications and testing), extracted from apple bark (Xi'an Aladdin Biological Technology Co., Ltd; No. 56 Xiaozhai Road, Ya to district, Xi'an, China). It is dark green or brown, and bitter—turns every item the same muddy color, is extremely unappetizing, and the bitterness makes the use with a sweetening agent impossible given the ratios required (the sweetness required to overcome the bitterness throws off the ideal ratio for the digestive reaction).

The bitterness itself is quite interesting. It has not been fully classified. It is likely a tannin, or simple alkaloid, which is why the hydroxylized version is not bitter. However, there is speculation that they are related to or part of the lactone group, among ethno-botanists, natural herbalists and pharmacologists. Interestingly, the sweet tea is from a different family so may lack these bitter properties. Note, there are currently NO known methods beyond the extraction to solid method, so any method to decolored, sweetened (which is removal of bitter compounds still in extract).

According to the present inventions, hydroxylzed phlorizin, with modified MAP (microwave assisted processing) is an effective procedure. Note that the hydroxlyzation procedure is commonly used in the final stages of the lecithin process, converting soybean oil to lecithin. It is a typical process for plant extraction, and is used to decolor (bleach), and remove bitter compounds.

As those skilled in the art understand, the present inventor has discovered a process which is new—however it is best understood by analogy to processing of other moieties, so it is helpful using lecithin as a base product to describe the process, the process is as follows: the crude soy oil is degummed, usually at the refinery of the company making commercial lecithin rather than at the oil mill. Crude soy oil contains an average of 1.8% (range 1.2-3.2%; Bailey 1951) hydratable compounds, primarily lecithin phosphatides. Roughly 1% of the live steam or warm water is added to the crude soy oil at about 70 degrees Celsius, in a batch or continuous process.

The emulsion is then agitated or stirred for 10-60 minutes as the phosphatides hydrate and agglomerate, forming a heavy oil-insoluble sludge, which is separated from the oil by use of a centrifuge. The sludge coming from the degumming centrifuge, a lecithin and water emulsion containing 25-30% water, may then be bleached once or twice, typically with hydrogen peroxide, to reduce its color from brown or beige to light yellow.

Fluidizing additives such as soy oil, fatty acids, or calcium chloride can then be added (if necessary) to reduce the viscosity to that of honey and prevent the end product, on cooling, from being a highly plastic solid. Finally, the product is film or batch dried to reduce the moisture to about 1% (Szuhaj 1980). Whether bleached or not, the finished product is called “unrefined lecithin” or “natural lecithin;” it contains 65-70% phosphatides and 30-35% crude soy oil. The oil in unrefined lecithin can be removed by extraction with acetone (phosphatides are insoluble to acetone) to give a dry granular product called “refined lecithin.”

The present inventor, without conceding the mechanism involved has discovered that the phlorizin process is identical, rather that it is similar, in that it is combined, agitated in a steam emulsion, separated by centrifuge and dried to a powder. The separation process can be repeated to increase purity. See FIG. 2, steps 111-119 which detail how at least one method to generate the phlorizin component of the instant Novel Bioadvantaged Sweetener is developed.

Further work has been done on the Purification Method. Namely, 2 Hydroxylation processes are offered, in the alternative. The first is easiest to conduct. The second has already been approved as GRAS (GRAS Exemption Claim for the use of Luo Han Fruit Concentrate, BioVittoria, Ltd., Hamilton, New Zealand, Jul. 22, 2009), but requires more equipment. To be added to conventional foods at the concentration needed, as a flavor modifier and sweetener. It may also be used as a tabletop sweetener. It may be used alone or as a component in sweetener blends. Several alternatives have been developed and are discussed below.

Hydroxylation. Current hydroxylation methods involve insertion of hydroxyl groups at the points of unsaturation in phospholipid fatty acid. The process involves blending of 14% of 100-volume hydrogen peroxide in the presence of an organic acid at elevated temperatures (40 to 75 degrees Celsius.) In lecithin processing, for example, current hydroxylation methods result in about 10% reduction in Iodine Value in about 1 to 3 hours of reaction time. The inventor used very high concentrations of hydrogen peroxide for the hydroxylation reaction and the phospholipids may get degraded due to the exposure of the lecithin to higher temperatures for longer reaction periods.

MAP. Using the process and reasoning behind U.S. Pat. No. 6,638,544 B2, regarding the use of microwave assisted processing for hydroxylated lecithin, the present inventor applies this to partially processed phlorizin. Using a percentage of starting range of 20-30% H₂O₂, with a low molecular weight acid that may be lactic acid but will most likely be citric or possibly a white acetic acid) and phlorizin, in similar ranges and compositions to those described in the previous application, at temperature, power and time of described previously, unless otherwise noted.

Alternative Techniques (GRAS). This processing method was approved for the PureLo brand of sweetener from the Luo Han Guo fruit company (commonly known as Monk Fruit) from the Hambrecht Group. Proctor & Gamble owns most of the manufacturing patents for this product, and uses them on the processing which they conduct in China. This process, however, was submitted to and approved by the FDA as conforming with GRAS (generally regarded as safe) procedures completing the purification process, particularly as the glycoside compounds being removed are likely similar.

Processing of Luo Han Fruit Concentrate. Processing methods are generally similar to those used to produce a number of other fruit-derived products. The fresh fruit is mechanically crushed or shredded. Macerated fruit is decocted for 30-40 minutes at 80 degrees Celsius with deionized water. The supernatant is allowed to cool to 50 degrees Celsius and is then clarified by passing through an ultrafiltration membrane to remove the large molecules of protein and pectin from the supernatant.

The supernatant is then passed through a pressurized resin-packed column. The resin is a divinylbenzene copolymer, a macroporous polymeric adsorbent which removes organic substances from aqueous flows. The resin achieves its effect by electrostatic site-specific attraction, binding the target compounds, principally mogrosides, while allowing unwanted compounds, including remaining traces of reducing sugars and mineral salts, to pass through into the waste stream. The action of the resin is mechanical rather than chemical and can best be compared to sieving or straining. Supernatant is continuously introduced into the columns until the binding surface of the resin (approximately 1000 m2/g) is fully saturated.

After the mechanical separation of components of the supernatant has been effected by the resin, the adhered material is released from the resin by elution with successive increments of food-grade aqueous ethanol solution. This process frees virtually all of the adsorbed material from the resin. The ethanol solution does not chemically change any of the compounds but merely brings them into solution. The eluent is heated to approximately 60 degrees Celsius and placed under partial vacuum, allowing the ethanol and bound water vapor to be condensed and recycled. The mother liquor is then cooled to approximately ambient temperature.

It is then subjected to a decolorizing step to separate the terpene glycosides in the solution from the melanoidins and other non-terpene glycoside molecules. This is achieved by contacting the mother liquor with a styrene divinylbenzene resin that adsorbs the solution. The decolorized mother liquor is then concentrated to approximately 40% soluble solids and spray-dried at 120 degrees Celsius in enclosed conditions, removing any remaining water and ethanol. After cooling to ambient temperature, the powder is sampled for analysis and sealed in Mylar-coated aluminum bags.

At the end of run, the resin is regenerated by flushing with a food-grade 0.2% solution of calcium hydroxide, followed by filtered water. Next, a food-grade 0.2% solution of hydrochloric acid is introduced to restore the neutral pH of the resin. Finally, the column is flushed with filtered water.

According to the instant teachings, the resultant Bioadvantaged Sweetener is used exactly the same way corn syrup (or, in denser quantity, high fructose corn syrup) would be used. The resultant Bioadvantaged Sweetener is a stable liquid that is quite viscous, can be stored and used, and works in the same manner as any invert sweetener to force the rough crystallization of heated and cooled sugar crystals to stay smooth (for candies/certain ice creams/sorbets and ice pops/frozen liqueur drinks, etc.). It can also be used to increase lifespan and stability of sweetened products, and, in dehydrated form, will increase shelf stability of sweetened shelf products—all without the use of fructose, sugar alcohols, chemicals or sugars that add caloric value. (In fact, this may mitigate some surrounding carbohydrate caloric value, depending on the amount and density of the carbohydrate with which it is combined.)

For approximately 225 g of Stabilized Sweetener, combine 100 g granulated lactose; 100 g granulated glucose; 200 g Damsker Processes Phlorizin; ⅓ cup water; ⅛ tsp salt; and ¼ tsp cream of tartar. Stir while brining to a boil, reduce to simmer and cover. Cook to a soft-ball stage and store.

There is also a Chinese eco-friendly process. Chinese Patent Application filed Apr. 17, 2012, published Aug. 22, 2012, CN 102643315 A is a low-environmental impact processing method for Phlorizin, note how easy it is to “decolorize phlorizine with lead oxide or an amount of chlorine”. The process is fairly straight-forward—it's basically retrieving the filtrate through alkaline and acidic washes, which are pretty common. They focus on the less “commercially industrial,” I suppose (e.g., NaOH). The interesting part is the bleaching with a wash of an environmentally neutral solution of something like active clay, diatomaceous earth, and (less environmentally sound from my perspective) animal bone—the sugar industry does this on some level. If it can bind the bitter compounds and decolor the entire batch with high rates of recovery, it is contemplated by the present invention.

While the method and apparatus have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference.

Finally, all references listed in the Information Disclosure Statement or other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant.

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC §132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

1. A process for generating and using enhanced sweeteners, which comprises, in combination:
determining sugar-related chemical properties designed;
selecting a sweetness level;
formulating a ratio of lactose (amorphous granulated) to glucose (granulated);
combining with a purified sweetener in amount approximately equal to at least about 10% of the total weight of the sugars;
utilizing the resultory bioadvantaged sweetener within a baked product produced at 400 degrees Fahrenheit or less; and
further processing and storage.

2. The process of claim 1, wherein the combining step uses phlorizin as the purified sweetener.

3. The process of claim 2, wherein the formulating step includes a ratio of approximately 1:1, 50% lactose (amorphous granulated) and 50% glucose (granulated).

4. The process of claim 2, wherein the phlorizin is at least about 98% pure, and a ratio of 1:1, or other ratios of lactose (amorphous granulated) and glucose (granulated) are used.

5. A product, by the process of claim 4, wherein glucometer readings from a user ingesting resultory product registers between 1 and 3 points higher than a user's base rate at 60 minutes out.

6. A product, by the process of claim 4, wherein stasis is achieved at a point of peak blood sugar saturation.

7. A product, by the process of claim 4, wherein the glucometer readings of a similar product using diabetic sugar would produce a range of between about 10 and 15 points higher, and a baked product using conventional sugar would range from about 33 to about 40 points higher on a glucometer.

8. The product of claim 7, having no measurable side effects on blood sugar, such as hypoglycemia in diabetics.

9. The resultory bioadvantaged sweetener of claim 2, wherein it is finished in powder form.

10. The resultory bioadvantaged sweetener of claim 9, being shelf-stable and free of fructose.

11. A novel bioadvantaged sweetener composition of matter, comprising, in combination:
a predetermined ratio of lactose, glucose and phlorizin; whereby stasis is achieved in the blood of a user both instantly and one-hour post ingestion.

12. The composition of matter of claim 11, which further comprises:
a delivery means for adding the concentration needed to render the same effective for being a flavor modifying agent and sweetener to palatable goods.

13. The composition of matter of claim 12, wherein said delivery means is a baked or confectionary good.

14. The composition of matter of claim 12, wherein said delivery means is a potable liquid-based consumable.

15. The composition of matter of claim 11, which further comprises:
at least a finishing methodology including heat and chemical processes effective to render said composition into a scalable powdered state readily applicable.

16. Novel enhanced Bioadvantaged Sweetening Agents, comprising, in combination:
at least a mixture of lactose (amorphous granulated) and glucose (granulated) in a predetermined ratio; and
substantially purified phlorizin in an amount equal to get at least about 10% of said mixture in an aliquot effective to combine with the same.

17. The novel enhanced Bioadvantaged Sweetening Agent of claim 16, further comprising a baked delivery system, produced at a range of temperature not to exceed 400 degrees Fahrenheit.

18. The Bioadvantaged Sweetening Agents of claim 16, embodied within a pharmaceutical product, nutraceutical product, or a pet food.

19. The Bioadvantaged Sweetening Agent of claim 16, wherein the same is embodied in at least one edible product selected from the group consisting of: baked goods; nutritional bars, powders, gels; supplements; cereals and grains; candies;
protein processed with sweetened agents; custards; sauces; condiments; confections;
syrups; flavors; jams and jellies; cake and pie fillings; beverages, including processed beverages; and related items.

20. The Bioadvantaged Sweetening Agent of claim 16, wherein consumption of edible products embodying the same has a negligible impact on the blood-sugar measurement of a user in mg/dL 60 minutes past consumption.
